(19) United States
(12) Patent Application Publication
(10) Pub. No.: US 2015/0316065 A1
(43) Pub. Date: Nov. 5, 2015

(54) MASS SEPARATION VIA A TURBOMOLECULAR PUMP

(71) Applicant: Honeywell International Inc., Morristown, NJ (US)

(72) Inventor: Wei Yang, Minnetonka, MN (US)

(21) Appl. No.: 14/577,253

(22) Filed: Dec. 19, 2014

Related U.S. Application Data
(63) Continuation of application No. 13/669,263, filed on Nov. 5, 2012, now abandoned.
(60) Provisional application No. 61/555,918, filed on Nov. 4, 2011.

(51) Int. Cl. F04D 19/04; G01N 1/40; F04D 29/32; B01D 53/24; F04D 29/54

(52) U.S. Cl. CPC F04D 19/042; B01D 53/24; F04D 29/542; F04D 29/325; G01N 1/4077

(57) ABSTRACT

A mass separation method utilizing a turbomolecular pump includes providing a gas, having analytes and ambient molecules, to an inlet chamber for allowing flow of gas into the pump, pulling gas into a pump chamber via motion of at least one of a rotor and a stator, positioning the rotor and stator such that the gas flows around an outer surface of one of the rotor or stator, and then inward toward a central axis and then toward a gas outlet, and wherein one or more target molecular or atomic species that are heavier than the ambient molecules in the gas at the inlet are passed through the chamber via the rotor and stator and a partial pressure of analytes in a gas at the outlet is increased by a larger factor than the ambient molecules at the outlet, resulting in an increase in the number analytes versus ambient molecules.

### CROSS REFERENCE TO RELATED APPLICATION

This application is a continuation of U.S. application Ser. No. 13/669,263, filed Nov. 5, 2012, which is a non-provisional application of U.S. Application Ser. No. 61/555,918, filed Nov. 4, 2011, the entire specification of which is incorporated herein by reference.

### STATEMENT OF GOVERNMENT RIGHTS

The subject matter of this disclosure was made with government support under the Government Program for the Defense Threat Reduction Agency (DTRA) and Defense Advanced Research Projects Agency (DARPA). Accordingly, the U.S. Government has certain rights to subject matter disclosed herein.

### TECHNICAL FIELD

The present disclosure relates to mass separation via turbomolecular pump methods, systems, and devices.

### BACKGROUND

For trace elemental and molecular detections, it is desirable, in some implementations, to enrich the target species prior to sending the sample to a detector or analytical instrument, such as an infrared spectrometer, photo acoustic analyzer, atomic absorption or emission spectrometer, or mass spectrometer. Mass-based separation can achieve this objective when the target species is of different atomic or molecular mass than the ambient gas.

However, currently available separation technologies, including centrifuge and diffusion based approaches, may not be suitable for sensor applications in some instances due to limited separative power, large size, and/or high power consumption, among other limitations.

Turbomolecular pumps can be used to selectively pump gases according to their molecular weight, however, conventional turbomolecular pumps can typically only effectively operate in very low pressures, such as below 10 millitorr, which may be too low for many analytical instruments and can require a large diameter conduit to transport the gas to achieve reasonable throughput.

### BRIEF DESCRIPTION OF THE DRAWINGS

FIG. 1 illustrates a flow diagram illustrating the fluid flow through a device in accordance with one or more embodiments of the present disclosure.

FIG. 2 illustrates an exploded view of a device in accordance with one or more embodiments of the present disclosure.

FIG. 3 illustrates a type of blade structure that can be utilized with embodiments of the present disclosure.

### DETAILED DESCRIPTION

Systems and devices for mass separation are described herein. Embodiments of the present disclosure provide a solution to these problems, for example, through use of a microscale turbomolecular pump. In some embodiments, a microscale turbomolecular pump can be capable of operating, for example, at 1000 times higher pressure than conventional turbomolecular pumps. In various embodiments, such pumps can provide higher separative power, lower power consumption, and/or smaller size than previous approaches, among other benefits.

Embodiments of the present disclosure can be based, for example, on a silicon micromachined turbomolecular pump which has monolithic blades that enable molecular pumping at higher pressures than previously possible. The blades can, for instance, be on a micron scale size. The blades can be formed in a number of stages, monolithically fabricated, and/or arranged in a radial direction, thereby enabling a high compression ratio at relatively low rotation speed.

Gases of higher molecular mass can attain a higher compression ratio through use of a turbomolecular pump than through use of other devices. Specifically, in some embodiments, the compression ratio can scale exponentially with the square root of the molecular mass of the material to be separated.

Therefore, if the one or more target molecular or atomic species are heavier than the ambient molecules (e.g., nitrogen) and are passed through a turbomolecular pump, in the outlet stream (i.e., the high pressure side), the partial pressure of the analytes could be increased by a larger factor than the ambient gas, which results in an effect of enrichment. The larger the mass ratio that exists between the analytes and the ambient gas molecules, the higher the enrichment factor that can be achieved.

In many gas analysis and detection applications, the analytes are much heavier than air and it is possible to achieve extremely high enrichment factors. For example, in a nitrogen background, a gas of molecular mass of 100 could be enriched by a factor of 30,000 when the background gas is compressed from 1 millitorr to 100 torr. In some embodiments, a relatively high outlet pressure (>100 torr) is helpful to the usefulness of the embodiment because it can be used by a wide range of analytical instruments and easily transported by small size tubes.

In comparison, a conventional turbomolecular pump, aside from its much larger size, would likely have limited output pressure, such as 3 millitorr in some implementations, which is less useful due to instrument and transport limitations, in some implementations. Also, with such a low outlet pressure and large compression ratio, the inlet pressure would likely have to drop to impractically low pressure levels.

The blades (e.g., fabricated by silicon micromachining) can allow the device to provide the high operating pressure of the microscale turbomolecular pump. In some embodiments, the monolithic nature of the fabrication method enables the creation of hundreds to thousands of monolithic pumping stages on a single rotor and/or stator disk, resulting in extremely high separative power in a small package with only one moving part.

Some embodiments of the present disclosure may be used in instrumentation where the application may be portable, hand held, and/or space limited. This is, in part, due to the blades being placed in rings and/or the placement of rings on the stator and rotor. Although discussed as a stator herein, in some embodiments, the stator may also be able to rotate, for example, in a direction opposite that of the rotation of the rotor.

In some embodiments, the present disclosure features a radial turbomolecular vacuum pump that includes a gas inlet, a gas outlet, a motor, a rotor, a stator, and a casing. The rotor includes a silicon rotor surface comprising monolithically fabricated micro blades. In such an embodiment, the stator can include a silicon stator surface comprising monolithically fabricated blades and grooves. The micro blades on the rotor and stator, respectively, can be arranged in multiple rings, and the rotor and stator disks can be placed in proximity, forming interdigitated stator and rotor blade rings. In such embodiments, the interdigitated stator and rotor blade rings form a multi-stage compression in a radial direction.

In some embodiments, the microfabrication allows for the creation of blades on the rotor and/or stator in dimensions smaller than the mean free path of gas molecules, even at the high limit of the exhaust pressure of 10 torr. With a silicon etching method used for monolithic fabrication, multiple blade rings can be made relatively easily and the number of stages of compression in the radial direction (e.g., 100 stages) can be achieved. One advantage of increasing the number of stages within each rotor and stator pairing is that the same compression ratio can be achieved at a lower rotor speed, leading to lower power consumption and less stringent bearing requirements.

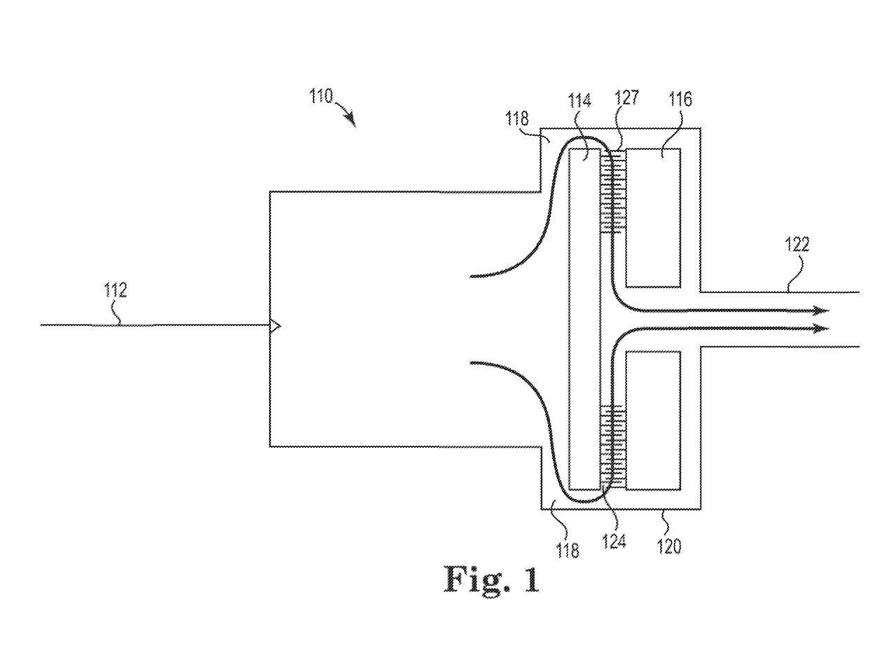

FIG. 1 illustrates a view of a radial flow turbomolecular pump 110. It should be understood that this is an example of a suitable pump type and that other types of turbomolecular pumps can be utilized within the scope of this disclosure.

The pump 110 includes an inlet 112, a rotor 114, a stator 116, a fluid flow path 118, a casing 120, and an outlet 122. The rotor 114 includes a plurality of rotor blades 124 and spaces formed between the blades. In some embodiments, the spaces can be formed by grooves created between the blades and although there are various mechanisms for forming these spaces, for ease of description herein, the spaces will generally be referred to as spaces or grooves and such terms should be viewed as meaning a space formed between the rows of blades. The stator 116 includes a plurality of stator blades 127 and spaces formed between the blades.

Casing 120 encloses rotor 114 and stator 116 and is designed to form a fluid flow path 118 around at least a portion of the outer edge of the rotor 114. As shown in FIG. 1, the fluid flow path 118 can provide flow around the entire circumference of rotor 114. Inlet 112 serves to allow an amount of fluid (e.g., gas) to enter casing 120 and flow around rotor 114.

Each groove of the plurality of stator grooves is positioned to receive a row of blades of the plurality of rotor blades 124. In the assembled state, stator 116 is fixed and rotor 114 is free to spin. In some embodiments, the position of the stator and rotor can be reversed with the fluid flow path formed around the stator. In some embodiments, the stator and rotor may both move.

A rotor circumferential speed can be in any suitable range. For example, the rotor circumferential range can be from 10 to 300 m/s, in some embodiments depending on a desired compression ratio and/or gas flow. The rotation of rotor 114 relative to stator 116 causes fluid to be pumped radially inward, toward an axial centerline (e.g., a center line passing perpendicularly through the center of the rotor or stator). The fluid is then directed into an outlet 122.

In operation, in some embodiments, a motor moves rotor 114 so that the rotor rotates relative to stator 116. When the rotor rotates, the plurality of rotor blades 124 passes through a respective one of the plurality of stator grooves.

As gas molecules enter via inlet 112, the plurality of rotor blades 124 and stator grooves impact the molecules, causing the molecules to gain momentum in a radial direction. This process is continued until the fluid molecules are lead through the outlet 122 and outside casing 120. In various embodiments, the dimension of the fluid flow path parallel to the rotor is greater than the dimension of the fluid flow path parallel to axial centerline of the rotor, resulting in a radial flow of the fluid molecules.

In some embodiments, one or more electrodes on one or both sides of the rotor and/or stator surface can be utilized to provide electrostatic levitation forces. This can be beneficial in keeping the rotor and stator from contacting each other and in reducing frictional forces.

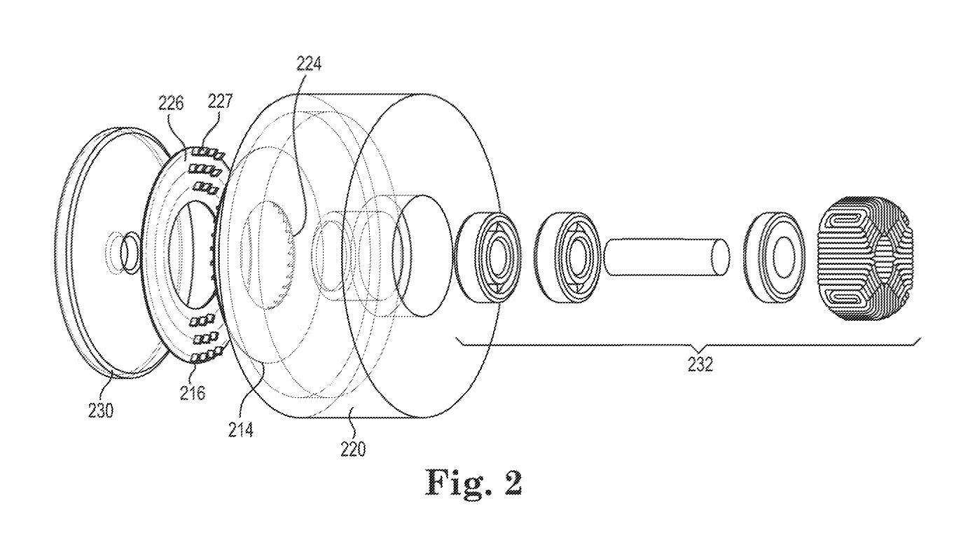

FIG. 2 illustrates an exploded view of a device in accordance with one or more embodiments of the present disclosure. In the embodiment of FIG. 2, the device includes a first casing portion 230 and a second casing portion 220, a rotor 214 having blades 224, a stator 216 having blades 227 and grooves 226, and a number of drive assembly components 232. In such an embodiment, the casing portions 220 and 230 form an interior cavity in which the rotor 214 and stator 216 are positioned and the positioning of the rotor 214 and stator 216 with respect to the inner wall of the casing portion 220 and inner surface of casing portion 230 defines the fluid flow path around the rotor and out the outlet.

As discussed above with respect to FIG. 1, the embodiment of FIG. 2 utilizes a motor to move rotor 214 so that the rotor rotates relative to stator 216. When the rotor rotates, the plurality of rotor blades 224 passes through a respective one of the plurality of stator grooves 226. In some embodiments, the rotor 214 and stator 216 can each be formed from a silicon substrate. Such embodiments, can be easier to manufacture than with other materials, for example, such substrates can be formed using etching and/or deposition techniques.

In various embodiments, the plurality of rotor blades 224 are arranged in concentric rings as will be discussed in more detail with respect to FIG. 5. A plurality of stator blades 227 and a plurality of stator grooves 226 are arranged on a surface of the stator 214 in stator concentric rings. As discussed above, the plurality of stator grooves 226 are arranged to fit between two of the concentric rings of rotor blades 224.

In some embodiments, the plurality of rotor blades 224 may be monolithically fabricated on a surface of the rotor 214, for example, using an etching process. Similarly, in various embodiments, the plurality of stator blades 227 may be monolithically fabricated on a surface of stator 216 using an etching process.

One suitable etching process may be deep reactive ion etching. In such a process, silicon substrates are placed inside a vacuum chamber and are usually grounded and electrically isolated from the rest of the chamber.

An etch mask is placed on the silicon substrate to selectively protect areas of the substrate. Gas enters the chamber and etches the unprotected portions of the silicon substrate; thus the substrate takes on a form that is dictated by the mask.

An example of a gas that may be used for this process is sulfur hexafluoride. However, the fabrication process is not limited to etching or using sulfur hexafluoride, and a number of other suitable processes or gases may be used.

For example, as an alternative to gas, plasma may be used to etch the silicon substrate. Another etching process may be photo assisted wet chemical etching. A plating process (e.g., Lithography, Electroplating, and/or Molding (LICA) type process) may be used as well. For example, in some such processes, a layer of photosensitive polymer is coated on the silicon substrate, followed by x-ray radiation using an x-ray mask.

In some embodiments, both sides of rotor 214 or stator 216 may be processed using an etching process. The etching process allows for the blades to be monolithically fabricated on the rotor. With monolithic fabrication, multiple rings of blades and grooves can be easily made, forming a large number of stages (i.e., rings of blades), for example, 100 stages (i.e., 50 rings and corresponding grooves on each rotor and stator totaling 100 rings of blades).

When the number of stages is increased, the same compression ratio can be achieved at a lower rotor speed. In such embodiments, when the turbomolecular pump operates at a lower rotor speed, less power is consumed which can be beneficial in some instances. For example, in applications where the pump will be utilized in a portable system or where power may need to be conserved or where low power is available, such embodiments can be beneficial.

Additionally, the ability to operate at a lower rotor speed can likely result in less stringent bearing requirements and less wear on the bearings of the turbomolecular pump.

In various embodiments, each blade of the plurality of rotor and/or stator blades 224 and/or 227 is thick enough to be stable under high speed rotation, yet thin enough for efficient compression. Such embodiments can be accomplished through use of the above described formation processes, but is not limited to such processes. In some embodiments, the size of each blade of the plurality of rotor and/or stator blades 224 and/or 227 can be approximately 10 micron, which allows the pump to work against 10 torr exhaust pressure. However, the blades are not limited to this size, and a number of other sizes may be used for other operating conditions.

FIG. 2 illustrates a rotor disk having rings of blades thereon for use in accordance with one or more embodiments of the present disclosure. As can be seen in this embodiment, the grooves are only slightly larger than the rings of blades allowing the grooves on the rotor (in this illustrated example) to accommodate the blades of the stator. Further, this figure illustrates the relationship between the rotor and the casing and shows the fluid flow path around the edge of the rotor. In this embodiment, the fluid flow path is formed around the entire circumference of the rotor.

Although the rotor is generally referred to with the number 214, the rotor can have multiple portions (e.g., layers). For example, in some embodiments, the blades and grooves can be formed on a substrate and attached to the surface of another component (e.g., a disk). This may be beneficial where a more durable rotor structure than the substrate (e.g., silicon substrate) may be needed. In some embodiments, it may be desirable, for instance, to have a rotor with more mass than that of the substrate material and so such embodiments may be useful in such implementations.

As discussed above with respect to FIG. 1, the embodiment of FIG. 2 utilizes a motor to move rotor 214 so that the rotor rotates relative to stator 216. For example, in the embodiment of FIG. 2, a number of drive components 332 can be attached to the rotor 214. The drive components can be directly or indirectly connected to a motor to drive the rotational movement of the rotor. As discussed above, in some embodiments the rotor and/or stator can be moveable with respect to each other.

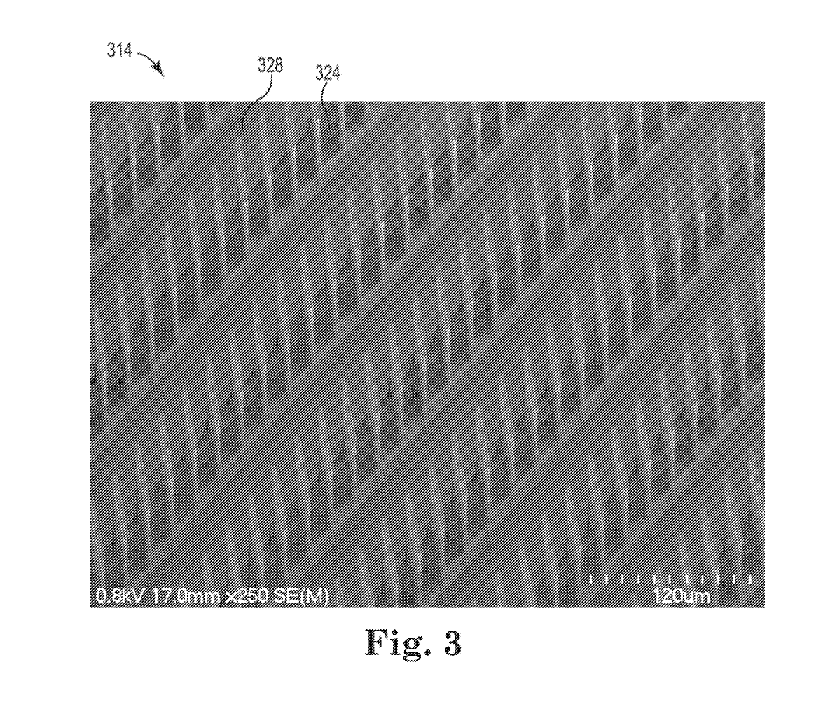

FIG. 3 illustrates a type of blade structure that can be utilized with embodiments of the present disclosure. The embodiment of FIG. 3 includes a number of rings of blades 324 and grooves 328 provided on a rotor 314, though a similar structure can be provided on the stator.

The plurality of rotor blades 324 are shaped and positioned to achieve a certain pumping speed, compression, and/or efficiency. The pitch of each blade of the plurality of rotor and/or stator blades generally determines the pumping speed and compression.

As an example, tilting the plurality of rotor and/or stator blades toward a more radial orientation will generally result in a higher pumping speed. Tilting the plurality of rotor blades toward a circumferential orientation will result in higher compression, yet lower pumping speed.

In some embodiments, the blades can be larger than others or their orientation can be different. For example, the plurality of rotor and/or stator blades near the center of rotor or stator (e.g., rotor 314) may be larger than the blades at the edge of rotor or stator, because the pressure near the center of rotor or stator is lower, in some implementations.

The silicon monolithic fabrication can allow for the stator and rotor to be manufactured in a small form factor. For example, in one embodiment, the stator and rotor can each be approximately 10 mm in diameter. However, the embodiments of the present disclosure are not limited to this size. Since these blade rings are arranged in a concentric structure, it is possible to have grooves that are sized only slightly larger than the width of the blades. As such, the rotor and stator blades can pass by each other as long as there is a sufficiently sized gap formed by the grooves. Such embodiments can result in very compact designs allowing for pumps of the present disclosure to fit in smaller devices, systems, and assemblies.

For example, in some embodiments where silicon monolithic fabrication is utilized, the process allows for the plurality of rotor blades to be made with high precision, so that each blade of the plurality of rotor blades fits within the corresponding stator groove within a specified tolerance. In some embodiments, a lateral clearance between at least one blade of the plurality of rotor blades and the first and second plurality of stator blades is approximately 5 micron. However, the distance is not limited to 5 micron, and may be any suitable size. In various embodiments, the rotor blades may be as close to the grooves as possible.

In some implementations, assembling the rotor and stator generally includes a tolerance of about 5 to 10 micron. This can be accomplished by assembling rotor and stator in a precision bore tubing after aligning and bonding rotor and stator to carrier disks, which can have precision matching outer diameters, in some implementations.

The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of devices” can refer to one or more devices. Additionally, the designator “N” as used herein, particularly with respect to reference numerals in the drawings, indicates that a number of the particular feature so designated can be included with a number of embodiments of the present disclosure.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method of mass separation utilizing a turbomolecular pump, comprising:
providing a gas, having analytes and ambient molecules therein, to an inlet chamber for allowing flow of gas into the pump;
pulling the gas into a rotor and stator casing via motion of at least one of a rotor and a stator therein;
positioning the rotor and stator such that the gas flows around an outer edge of one of the rotor or stator, inward toward a central axis, and then toward a gas outlet; and
wherein one or more target molecular or atomic species that are heavier than the ambient molecules in the gas at the inlet are passed through the rotor and stator casing via the rotor and stator and a partial pressure of analytes in a gas at the outlet is increased by a larger factor than the ambient molecules at the outlet, which results in an increase in the number analytes versus ambient molecules at the outlet.

2. The method of mass separation utilizing a turbomolecular pump of claim 1, positioning the rotor and stator such that the gas flows inward toward a central axis through a number of rotor blades positioned on the rotor and number of stator blades positioned on the stator.

3. The method of mass separation utilizing a turbomolecular pump of claim 1, wherein the method includes determining a compression ratio of the pump based on the square root of a molecular mass of a material to be separated from a gas at the inlet.

4. The method of mass separation utilizing a turbomolecular pump of claim 1, wherein the method includes rotating the stator in a direction opposite that of a rotation of the rotor to pull the gas into the rotor and stator casing.

5. The method of mass separation utilizing a turbomolecular pump of claim 1, wherein the method includes providing blades on at least one of the rotor and stator that have dimensions smaller than a mean free path of a gas molecule.

6. The method of mass separation utilizing a turbomolecular pump of claim 1, wherein positioning the rotor and stator such that the gas flows around an outer edge of one of the rotor or stator includes positioning the rotor and stator such that the gas flows around an entire circumference of the rotor.

7. The method of mass separation utilizing a turbomolecular pump of claim 1, wherein the method includes determining an enrichment factor based on a mass ratio between the analytes and the ambient molecules.

8. A method of mass separation utilizing a turbomolecular pump, comprising:
providing a gas, having analytes and ambient molecules therein, to an inlet chamber for allowing flow of gas into the pump;
pulling the gas into a rotor and stator casing via motion of a rotor in a first direction and motion of a stator in a second direction to form a multi-stage compression of the gas in a radial direction;
positioning the rotor and stator such that the gas flows around an outer edge of one of the rotor or stator, inward toward a central axis, and then toward a gas outlet; and
wherein one or more target molecular or atomic species that are heavier than the ambient molecules in the gas at the inlet are passed through the rotor and stator casing via the rotor and stator.

9. The method of mass separation utilizing a turbomolecular pump of claim 8, wherein positioning the rotor and stator includes positioning the rotor and stator such that the gas flows around an entire circumference of the rotor.

10. The method of mass separation utilizing a turbomolecular pump of claim 8, wherein positioning the rotor and stator includes positioning the rotor and stator such that a rotor circumferential range is between 10 meters per second (m/s) and 300 m/s.

11. The method of mass separation utilizing a turbomolecular pump of claim 8, comprising positioning one or more electrodes on both sides of the rotor and stator surface.

12. The method of mass separation utilizing a turbomolecular pump of claim 11, wherein positioning one or more electrodes includes providing electrostatic levitation forces to prevent the rotor and stator from contacting.

13. The method of mass separation utilizing a turbomolecular pump of claim 8, comprising compressing background gas between 1 militorr and 100 torr.

14. A method of mass separation utilizing a turbomolecular pump, comprising:
providing a gas, having analytes and ambient molecules therein, to an inlet chamber for allowing flow of gas into the pump;
pulling the gas into a rotor and stator casing via motion of a rotor in a first direction and motion of a stator in a second direction to form a multi-stage compression of the gas in a radial direction;
positioning the rotor and stator such that the gas flows in a gas path around an outer edge of one of the rotor or stator, radially inward toward an axial centerline, and then toward a gas outlet; and
wherein one or more target molecular or atomic species that are heavier than the ambient molecules in the gas at the inlet are passed through the rotor and stator casing via the rotor and stator.

15. The method of mass separation utilizing a turbomolecular pump of claim 14, wherein positioning the rotor and stator includes positioning the rotor and stator such that gas flows radially inward toward an axial centerline, wherein the axial centerline is a center line passing perpendicularly through a center of the rotor.

16. The method of mass separation utilizing a turbomolecular pump of claim 14, wherein positioning the rotor and stator includes positioning the rotor and stator such that gas flows radially inward toward an axial centerline, wherein the axial centerline is a center line passing perpendicularly through a center of the stator.

17. The method of mass separation utilizing a turbomolecular pump of claim 14, wherein positioning the rotor and stator includes positioning the rotor and stator such that the dimension of the gas path parallel to the rotor is greater than a dimension of the gas path parallel to an axial centerline of the rotor.

18. The method of mass separation utilizing a turbomolecular pump of claim 14, wherein positioning the rotor and stator includes positioning the rotor and stator such that the gas path is formed around an entire circumference of the rotor.

19. The method of mass separation utilizing a turbomolecular pump of claim 14, comprising producing an outlet pressure of the gas to a pressure greater than 100 torr.

20. The method of mass separation utilizing a turbomolecular pump of claim 14, wherein positioning the rotor and stator includes positioning the rotor and stator such that the rotor and stator are placed in proximity to form an interdigitated stator and rotor blade rings.
